(19) United States
(12) Patent Application Publication
(10) Pub. No.: US 2015/0220760 A1
(43) Pub. Date: Aug. 6, 2015

(54) ENHANCED SECURITY DISPLAY TECHNOLOGY

(71) Applicants: Richard Foote, Hillsboro, OR (US); Giuseppe Raffa, Portland, OR (US); Jacob J. Gauthier, Hillsboro, OR (US); Brett G. McKown, Hillsboro, OR (US)

(72) Inventors: Richard Foote, Hillsboro, OR (US); Giuseppe Raffa, Portland, OR (US); Jacob J. Gauthier, Hillsboro, OR (US); Brett G. McKown, Hillsboro, OR (US)

(21) Appl. No.: 14/128,106

(22) PCT Filed: Oct. 31, 2013
(86) PCT No.: PCT/US2013/067689

§ 371 Date: Dec. 20, 2013

(51) Int. Cl. G06F 21/84; G09G 3/36; G06F 21/60

(52) U.S. Cl. CPC G06F 21/84; G06F 21/606; G09G 3/36; G09G 2358/00

(57) ABSTRACT

Technology for enhancing the security of content on an electronic display is described. In some embodiments, the technology utilizes infrared light emitted from an infrared light source integrated into an electronic display to produce infrared security indicia. The infrared security indicia may obscure all or a portion of a recording of the electronic display produced by an electronic recording device that includes a photodetector sensitive to infrared and visible light.

### TECHNICAL FIELD

The present disclosure generally relates to technology for enhancing the security of electronic displays and, more particularly, to technology that improves the security of content displayed on an electronic display through the use of infrared security indicia.

### BACKGROUND

Electronic devices are commonly used to perform sensitive tasks, such as viewing confidential communications, confidential technical information, etc. While useful for such tasks, such devices generally rely on the use of a display to convey confidential and other information to a user. In many instances, electronic displays do not protect the content displayed thereon from being viewed by third parties and/or recorded by other electronic devices. Confidential information on the display of a mobile or other electronic device may therefore be compromised, e.g., by a third party that captures the content of the display, e.g., via photography, video recording, screen capture, or some other means.

For example, a businessman may use a laptop to review a confidential electronic message while waiting for a plane in an airport. While reviewing the message, a tourist photographing a plane may unintentionally photograph the content of the laptop's display, including the confidential message displayed thereon. This may compromise the security of the confidential message, particularly if the photograph is distributed to unauthorized third parties, e.g., via the internet, a social network, or some other means.

Demand has therefore increased for mechanisms for securing the content of electronic displays from risks posed by electronic recording devices such as video and still cameras, as well as the eyes of third parties. To this end, technologies such as polarized display filters have been developed. Such filters are often configured to fit over an electronic display, and function to restrict the angle(s) (i.e. field of view) from which the content of a display may be viewed by a user.

Although polarizing filters are effective in some applications, they do not provide an ideal user experience. This is particularly true in instances where a user has multiple devices with different displays, in which case the user may have to inconveniently carry a separate filter for each display. In addition, some polarizing filters can substantially diminish the intensity (brightness) of a display, potentially making the display difficult to read even by a user within the filter's limited field of view. Polarizing filters may also not address the specific risks posed by electronic recording devices, which may still capture and memorialize confidential information on the display if they are brought within the filter's limited field of view.

A need therefore remains in the art for technologies that can improve the security of content as it is viewed on an electronic display. The present disclosure aims to address that need.

### BRIEF DESCRIPTION OF THE DRAWINGS

FIG. 1 depicts one exemplary embodiment of an enhanced security display consistent with the present disclosure.

FIG. 2 depicts an exemplary embodiment of an enhanced security display including an infrared light source above an optically active layer, consistent with the present disclosure.

FIG. 3 depicts another exemplary embodiment of an enhanced security display including an infrared light source above an optically active layer, consistent with the present disclosure.

FIG. 4 depicts an exemplary embodiment of an enhanced security display including an infrared light source below an optically active layer, consistent with the present disclosure.

FIG. 5 depicts another exemplary embodiment of an enhanced security display including an infrared light source below an optically active layer, consistent with the present disclosure.

FIGS. 6A provides top down and magnified views of a backlight unit consistent with the present disclosure.

FIG. 6B illustrates exemplary security indicia produced in a recording of an electronic display consistent with the present disclosure.

FIG. 7 illustrates an exemplary liquid crystal pixel consistent with the present disclosure.

FIG. 8 depicts an exemplary method of producing infrared security indicia, consistent with the present disclosure

### DETAILED DESCRIPTION

As briefly described in the background, electronic displays are increasingly being used to review confidential information. With the increased use of electronic recording devices, content displayed on an electronic display may be subject to an increased risk of accidental or intentional recording. With this in mind, the present disclosure generally relates to technologies for enhancing the security of content displayed on an electronic display from threats posed by electronic recording devices. In particular, the present disclosure generally relates to technologies for causing the production of security indicia in electronic recordings of a display. As will be described in detail below, the technologies described herein may cause an electronic recording device to produce security indicia in a recording of an electronic display, wherein the security indicia at least partially obscures all or a portion of the recording of the display.

Electronic recording devices such as digital cameras, digital video recorders, smart phone cameras and the like often include a photodetector (also called an image sensor) such as a charge coupled device (CCD), complementary metal oxide semiconductor (CMOS), or the like. Such photodetectors include a plurality of photosites, which can detect and convert light entering the recording device to electrons. The photodetector output may then be processed into image data reflective of the scene that is being recorded, using means that are well understood in the digital recording arts.

Although electronic recording devices are commonly used to record visible light from a scene (e.g., in a photography or video operation), the photodetectors of such devices often include photosites that are sensitive to infrared light. As will be described below, the technologies described herein can leverage the infrared sensitivity of photodetectors to hinder or prevent them from accurately reproducing content in a recording of an electronic display.

The term “content” is generally used herein to refer to information that is displayed on an electronic display in such a manner as to be perceived by human eyes. Non-limiting examples of content therefore include text, images, patterns, etc., which are displayed on an electronic display with light in the visible region of the electromagnetic spectrum.

The term “electronic display” is used herein to refer to any of the wide variety of displays that may be implemented in an electronic device, such as those defined below. Non-limiting examples of electronic displays include liquid crystal displays (LCD's), organic light emitting diode (OLED) displays, cathode ray tube (CRT) displays, plasma display panels (PDP), rear or front projection displays, combinations thereof, and the like. For the sake of clarity and ease of understanding, an electronic display in the form of an LCD is often used herein to describe the implementation of various embodiments of the present disclosure. It should be understood that such description is exemplary only, and that the technologies described herein may be implemented in any desired type of electronic display. Without limitation, the electronic displays described herein are preferably in the form of a thin film transistor (TFT) LCD.

The term “electronic device” refers to any of the wide variety of mobile and stationary devices that may include an electronic display. Non-limiting examples of electronic devices include mobile devices such as cellular phones, electronic readers, handheld game consoles, mobile internet devices, portable media players, personal digital assistants, smart phones, tablet personal computers, ultra-mobile personal computers, netbooks, and notebook computers. Further non-limiting examples of electronic devices that may be used include movie screens, billboards, televisions, desktop computer monitors (including by not limited to LCD monitors), automated teller machines, kiosks, payment terminals, public computer terminals, watches, and wired telephones (including but not limited to internet enabled telephones).

The phrase, “electronic recording device” is used herein to refer to any of the wide variety of devices that capable of recording images or video of a scene using at least one photodetector. Non-limiting examples of electronic recording devices include camcorders, cellular phone cameras, digital cameras, digital video cameras, smart phone cameras, television cameras integrated into electronic devices such as electronic readers, laptop computers, tablet personal computers, phones, televisions, etc. combinations thereof, and the like. In some embodiments, the electronic recording devices include at least one photodetector that is sensitive to visible and infrared light.

From time to time, the present disclosure may describe one or more software components that may be utilized in association with the present disclosure. In many instances, it is noted that such software components may take the form of at least one computer readable medium (such as a storage medium) having computer readable instructions stored thereon which when executed by a processor cause the processor to perform functions associated with the software component. While such implementation may or may not be preferred, it should be understood that any of the software components described herein may be implemented in another manner. For example, such components may take the form of hard coded logic, a hardware processor, one or more software modules, and the like.

The term “infrared security indicia” is used herein to refer to text, images, symbols, combinations thereof, and the like, which are produced by an electronic display with light that is within the infrared region of the electromagnetic spectrum. As briefly discussed above, the infrared light making up the infrared security indicia may be imperceptible by a human but may be detected by an electronic recording device. Electronic recording devices detecting the infrared light may therefore produce a visible representation of the infrared security indicia within a recording of an electronic display, such as a photograph, video, combinations thereof, and the like. The visible representation of the security indicia may obscure all or a portion of the recording of the electronic display, as will be discussed later.

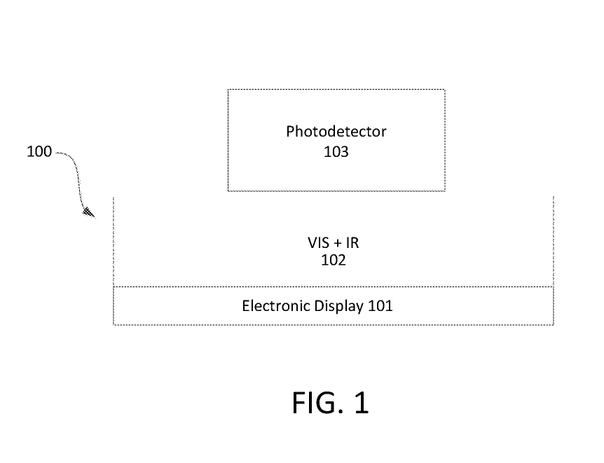

Without wishing to be limited by theory, it is believed that infrared light making up the infrared security indicia may stimulate and/or saturate photosites of the photodetector(s) used in various electronic recording devices, such as photodetector 103 illustrated in FIGS. 1-5. This stimulation/saturation is believed to cause all or a portion of a recording produced by the electronic recording device to be over exposed (i.e., “washed out”). By controlling the distribution of infrared light emanating from an electronic display, the technologies described herein may cause an electronic display to produce infrared security indicia. The infrared security indicia may cause all or a portion of the content of an electronic display to be obscured in a recording of the display produced by an electronic recording device. Similarly, stimulation/saturation of photosites by the infrared security indicia may cause the electronic recording device to produce a visible representation of the infrared security indicia (e.g., a watermark) within a recording of the electronic display.

Because human eyes cannot perceive infrared light, infrared security indicia emanating from an electronic display may not be visible until it is reproduced in a recording of the electronic display. Therefore in addition to providing a mechanism for enhancing the security of content on an electronic display, infrared security indicia may also provide the added benefit of not interfering with the practical use of the electronic display, e.g., by an authorized user.

With the foregoing in mind, one aspect of the present disclosure relates to enhanced security displays that employ infrared light to hinder or prevent the recording of content displayed thereon by an electronic recording device. Reference is therefore made to FIG. 1, which is a high level diagram of an enhanced security display 100 consistent with the present disclosure. In this embodiment, enhanced security display 100 includes electronic display 101, which is configured to display content (not illustrated) such as text, images, combinations thereof, and the like. Electronic display 101 may produce such content within a display area thereof (not illustrated) using visible light (i.e., light in the visible region of the electromagnetic spectrum). Content within the display area may thus be perceived by human eyes, e.g., which may observe the visible light corresponding to such content emanating from electronic display 101, e.g., in region 102.

In addition to displaying content, electronic display 101 is also configured to produce infrared security indicia (not illustrated) that emanates from all or a portion of its display area. As will be described in detail later in connection with other FIGS., the infrared security indicia may be produced at least in part using an infrared light source that is incorporated into electronic display 101. Infrared light making up the infrared security indicia may emanate from electronic display 101, e.g., into region 102. As generally described above, the infrared security indicia produced by electronic display 101 may be configured to cause an electronic recording device to produce a visible representation of the infrared security indicia in a recording of the device. The visible representation of the infrared security indicia may obscure all or a portion of the electronic display in the recording.

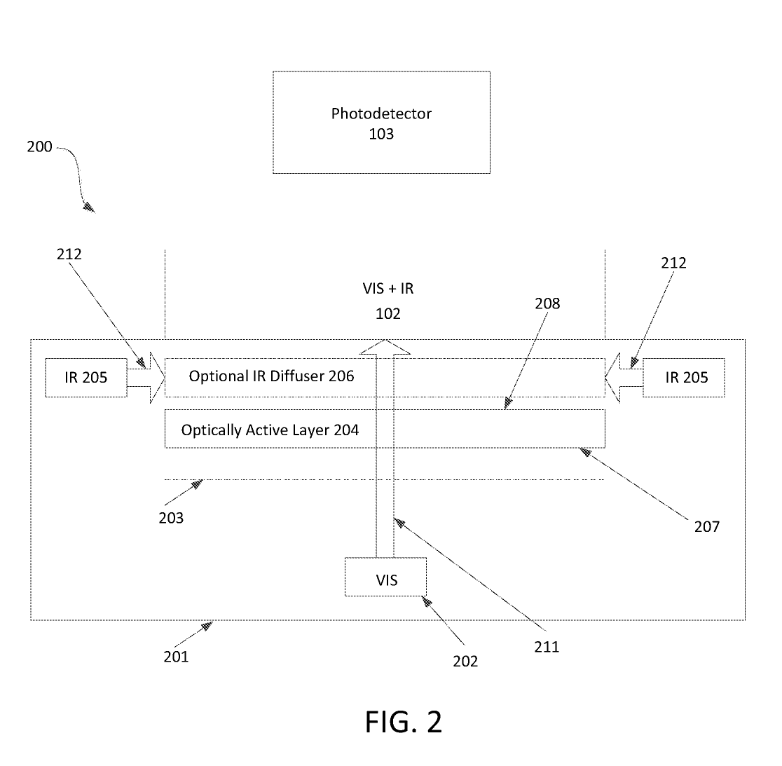

FIG. 2 illustrates another exemplary enhanced security display consistent with the present disclosure. As shown, enhanced security display 200 includes electronic display 201. Electronic display 201 includes visible light source 202, optically active layer 204, and infrared light sources 205. Electronic display 201 may optionally include visible light diffuser 203 and infrared light diffuser 206, the optional nature of each of which is illustrated with broken lines. It is noted that FIG. 2 (and the other FIGs) have been illustrated with limited components. It should be understood that such illustrations are for the sake of clarity and ease of understanding, and that the displays of the present disclosure may include other components commonly found in electronic displays.

Visible light source 202 generally functions to provide visible light for producing content on a display area (not illustrated) of electronic display 201. Visible light source 202 may therefore be any source of visible light that is suitable for this function. For example, visible light source may be a cold cathode fluorescent lamp (CCFL), a hot cathode fluorescent lamp (HCFL), an incandescent bulb, a high intensity discharge source, a plasma source, one or more light emitting diode (LED) sources, combinations thereof, and the like. In some embodiments, visible light source 202 is a CCFL light source, one or more LED sources, or a combination thereof. Without limitation, visible light source 202 is preferably a plurality of LED sources. The plurality of LED sources may for example include a plurality of single color LEDs, such as red, green, and blue LEDs. In some embodiments, visible light source 202 may be included in a backlight unit (not separately illustrated) of electronic display 201.

Regardless of its nature, visible light source 202 may generally operate to emit visible light 211. Visible light 211 may be emitted or otherwise directed (e.g., with one or more reflectors) towards an outlet of electronic display 201, such as a display area (not separately illustrated) thereof. In embodiments wherein optional visible light diffuser 203 is used, such diffuser may function to diffuse incident visible light, such that downstream visible light (e.g., which impinges on optically active layer 204) may be more uniform in intensity and/or distribution than the visible light upstream of visible light diffuser. In this regard, optional visible light diffuser 203 may be any type of optical diffuser suitable for diffusing visible light, such as but not limited to visible light diffusers employed in modem liquid crystal displays.

Optically active layer 204 generally functions to produce content within a display area (not shown) of electronic display 201, e.g., using visible light 211. For example, optically active layer 204 may be configured to selectively block or transmit visible light 211, e.g., using a liquid crystal layer. In such instances electronic display 201 may be understood as illustrating a liquid crystal display. As may be generally understood in the art of liquid crystal displays, a liquid crystal layer may selectively block or transmit visible light based on the orientation of the liquid crystals within the layer. Therefore in embodiments in which optically active layer 204 includes a liquid crystal layer, electronic display may further include other components of liquid crystal displays that may enable optically active layer 204 to perform its function, such as one or more polarizers, electrical contacts for driving individual LCD cells, etc.

Any suitable type of liquid crystal layer may be used in optically active layer 204. As exemplary types of such liquid crystal layers, mention is made of twisted nematic (TN) liquid crystals, in plane switching (IPS) liquid crystals, super-in plane switching (S-IPS) liquid crystals, advanced fringe field switching liquid crystals. Such liquid crystals are preferably configured to include a plurality of liquid crystal cells, which may be individually addressed using active matrix technology (e.g., thin film transistors) and/or some other means.

Of course, optically active layer 204 need not be configured to include a liquid crystal layer. Indeed, optically active layer may be any suitable type of layer that can function to produce content within a display area of electronic display 201. For example, optically active layer 204 may be configured to include one or more phosphors, such as those that may be found in cathode ray tube displays and/or plasma displays. When used, such phosphors may be stimulated by incident visible light 211, after which they may relax and reradiate light in another region of the visible spectrum. In such instances, electronic display 201 may include other elements which enable the production of content using a phosphor based layer, such as may be found for example, in a cathode ray tube display, plasma display, or other phosphor based display.

In any case, visible light 211 may be used to produce content within a display area of electronic display 201. This concept is generally shown in FIG. 2 by the projection of an arrow designating visible light 211 through optically active layer 204 to a display area (not separately illustrated) of electronic display 201. It should be understood that the portion of visible light downstream of optically active layer 204 generally corresponds to content to be displayed on electronic display 201. Visible light representative of such content may emanate from electronic display 201 into region 102, where it may be detected by photodetector 103, e.g., of an electronic recording device.

Infrared (IR) light sources 205 generally function to add IR light 212 to the total light emanating from electronic display 201 into region 102. In this regard, IR light sources 205 may be any suitable source that is capable of emitting infrared light 212 at a desired intensity. As non-limiting examples of suitable sources that may be used as IR light sources 205, mention is made of light emitting diodes that emit in the infrared region of the electromagnetic spectrum. Other suitable IR light sources include infrared lasers, infrared emitting phosphors, infrared emitting light emitting diodes (LEDS), combinations thereof, and the like. Without limitation, IR light sources 205 are preferable one or more infrared emitting LEDs.

One purpose of the addition of infrared light 212 may be to hinder or prevent an electronic recording device including photodetector 103 from recording content produced by electronic display 201. In this regard, IR light sources 205 may be configured to emit and introduce IR light 212 into region 102 at a sufficient intensity to excite and/or saturate photosites within photodetector 103. In this regard, IR light sources 205 may be configured to emit IR light 212 directly into region 102. Alternatively or additionally, IR light sources 205 may be configured to introduce IR light 212 generally into a display area of electronic display 101, such that it may emanate from the display area into region 102.

The location and orientation of IR light sources 205 may impact their ability to introduce IR light 212 into region 102. Careful control over the position and orientation of IR light sources 205 may therefore be desired, so as to facilitate the sufficient introduction of IR light 212 into region 102. With this in mind, IR light sources 205 may be positioned in any suitable location, including below optically active layer 204, above and normal to optically active layer 204, below and normal to optically active layer 204, at an angle from optically active layer 204, combinations thereof, and the like.

FIG. 2 illustrates an exemplary embodiment wherein optically active layer 204 includes a lower surface 207 proximate to visible light source 202, an upper surface 208 distal to visible light source 205, and IR light sources 205 that are positioned such that they are offset from upper surface 208. IR light sources 205 in FIG. 2 are also oriented substantially normal to upper surface 208. In such orientation, IR light sources may emit IR light 212 at an angle that is substantially perpendicular to upper surface 208 of optically active layer 204. In some embodiments, such orientation may enable IR light sources 205 to introduce IR light into a display area of electronic display 201. IR light 212 so introduced may diffusely emanate from the display area of electronic display 201 include region 102, where it may be detected by photosites of photodetector 103.

In some embodiments, electronic display 201 may include optical components to facilitate and/or enhance the distribution of IR light 212 within region 102, such as optional IR diffuser 206. Optional IR diffuser 206 may be any type of optical diffuser that is capable of diffusing infrared light. In some embodiments, IR diffuser 206 may be configured so as to diffuse IR light 212 from IR light sources 205 across all or substantially all of the display area of electronic display 201. For example, IR diffuser 206 may be configured such that the distribution and/or intensity of IR light 212 is equal or substantially equal across all or substantially all of the display area of electronic display 102. In such instances, the distribution and/or intensity of IR light 212 emanating from electronic display into region 102 may be equal or substantially equal across all or substantially all of the display area of the electronic display.

Visible light 211 (e.g., corresponding to content) and infrared light 212 (e.g., corresponding to infrared security indicia) within region 102 may be detected by an electronic recording device that includes a photodetector, such as photodetector 103. In instances where IR light 212 emanates from all or substantially all of the display area of electronic display 201, all or substantially all of a recording produced by the electronic recording device including photodetector 103 may be over exposed, or “washed out”. In this way, the enhanced security display of FIG. 2 may cause all or substantially of the content produced by electronic display 201 to be at least partially or fully obscured within a recording produced by the electronic recording device.

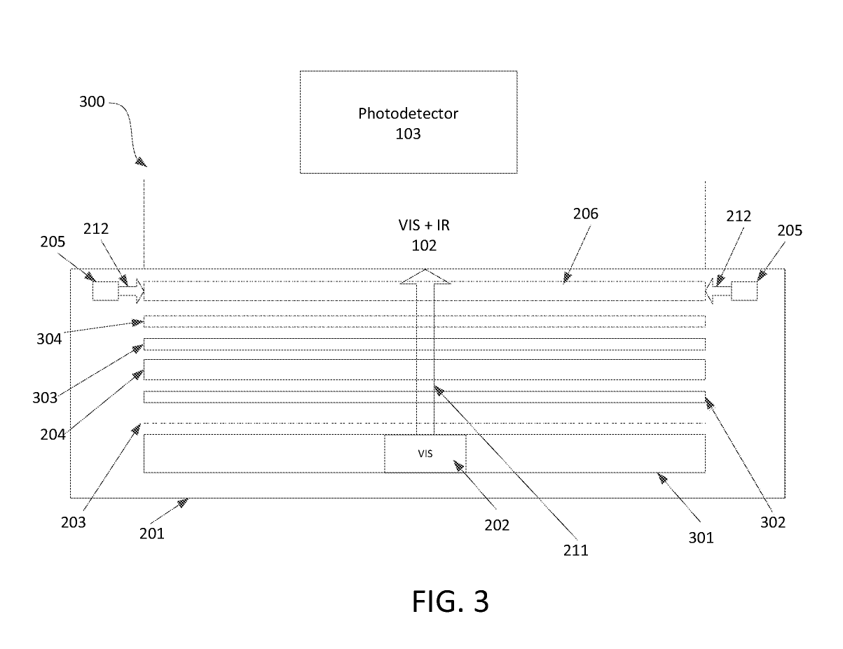

FIG. 3 depicts another exemplary enhanced security display consistent with the present disclosure. As shown, enhanced security display 300 includes electronic display 201, which is configured to perform in substantially the same manner as described above in connection with FIG. 2. Accordingly, electronic display includes visible light source 202, optional visible light diffuser 203, optically active layer 204, and IR light sources 205. In this embodiment, optically active layer 204 includes a liquid crystal layer, such as a twisted nematic liquid crystal layer. Accordingly, electronic display 201 in FIG. 3 is further illustrated as including other elements which may enable optically active layer 204 to selectively block or transmit visible light 212 using a liquid crystal layer. In particular, electronic display 201 is illustrated as including first polarizer 302 and second polarizer 303. Additionally, electronic display 201 includes backlight unit 301 including visible light source 202. Optional color filter layer 304 may also be included, e.g., to facilitate the production of color content with electronic display 201.

Backlight unit 301 may be any suitable backlight for a liquid crystal display. For the sake of clarity, backlight unit 301 is illustrated in FIG. 3 as including a single visible light source 202. It should be understood that such illustration is exemplary, and any number of visible light sources may be used. In some embodiments, backlight unit includes a plurality of visible light sources 202, such as about 2, 5, 10, 20, 50, 100, 1000, or more visible light sources. Without limitation, backlight unit preferably includes a plurality of visible light sources 205, wherein each of such sources is a light emitting diode source (e.g., red, green, blue LEDs).

Consistent with the description of FIG. 2, visible light sources 202 within backlight unit 301 may emit visible light 211, which may impinge on optional visible light diffuser 203. Visible light diffuser may diffuse the incident visible light, as generally described above. The visible light may then impinge on first polarizer 302.

In this embodiment first polarizer 302 is generally configured as an optical filter that transmits visible light waves of a specific polarization, while blocking visible light waves that are of other polarizations. Thus for example, first polarizer may be configured as a vertical or horizontal polarizer. Such polarizers may pass light waves within visible light 212 that have the correct (e.g., vertical or horizontal) polarization, while blocking light waves with other polarization(s). More generally, first polarizer 302 may be configured to transmit light visible light waves having a first polarization, while blocking or substantially blocking light waves with other polarization(s).

Consistent with the foregoing, first polarizer 302 will transmit the portion of visible light 211 having the correct polarization. The resulting polarized visible light (not separately labeled) may then impinge on optically active layer 204, which in this embodiment includes a liquid crystal layer. The liquid crystal layer in optically active layer 204 is configured to selectively transmit or block the incident polarized visible light, e.g., based on an orientation of liquid crystal cells contained therein, as generally understood in the art of liquid crystal displays. In this process, the polarization of all or a portion of the incident polarized light (from first polarizer 302) may be changed, e.g., to a second polarization matching that of second polarizer 304. Visible light 211 downstream of optically active layer 204 and having the correct polarization may be transmitted by second polarizer 304, which is configured to block visible light of other polarizations. Visible light 211 downstream of second polarizer 304 may correspond to content with a display area of electronic display 201, as generally described above.

Any type of polarizer may be used as first and second polarizers, so long as such polarizers are capable of filtering visible light waves based on their polarization. Thus for example, either or both first and second polarizers 302, 304 may be in the form of a wire grid polarizer, a polarizing film, an absorptive polarizer, a beam splitting polarizer, combinations thereof, and the like. Without limitation, first polarizer 302 preferably has a first polarization (horizontal/vertical), and second polarizer 304 has a second polarization opposite the first polarization.

As further shown in FIG. 3, enhanced security display further includes IR light sources 205 and in some instances, optional IR diffuser 206. Such elements function in the same manner as described above in connection with FIG. 2, and so are not described again in detail for the sake of brevity. In general, such components function to add IR light 212 to the total light emanating from electronic display 201, so as to obscure all or a portion of its display area in a recording produced by an electronic recording device including photodetector 103.

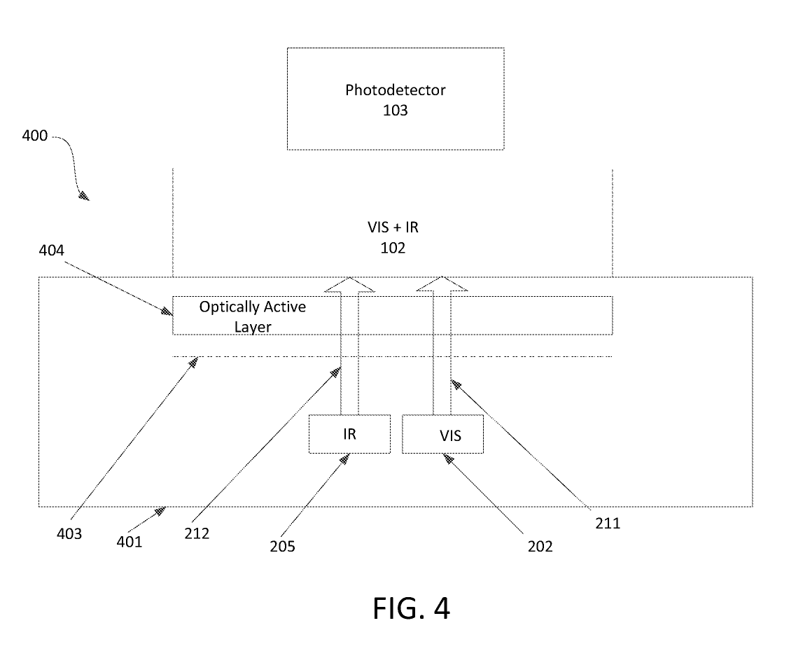

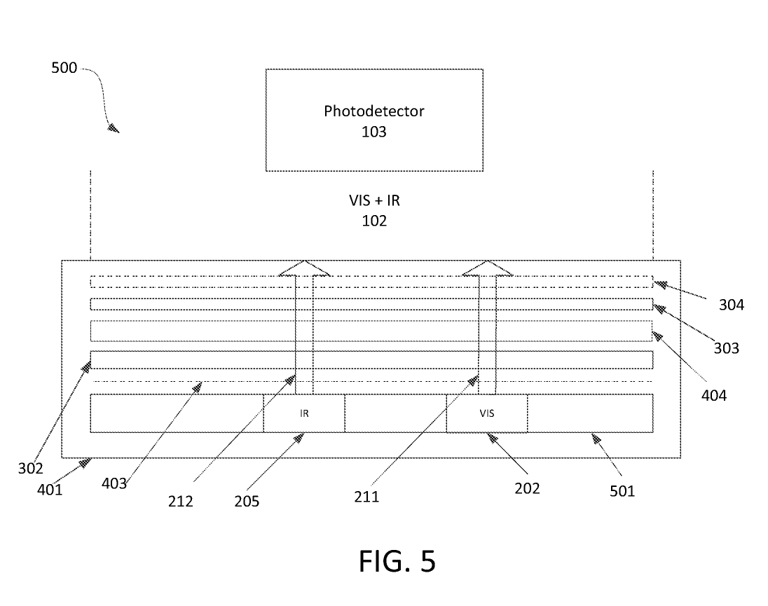

As noted previously, the position and orientation of IR light sources in the present disclosure may have a meaningful impact on the ability of such sources to introduce infrared light to the light output from an electronic display. With this in mind, reference is made to FIGS. 4 and 5, which depict exemplary enhanced security displays consistent with the present disclosure, and which include a source of infrared light positioned below an optically active layer.

With specific reference to FIG. 4, enhanced security display 400 includes electronic display 401, which in turn includes visible light source 202, infrared light source 205, optional diffuser(s) 403, and optically active layer 404. Like the embodiments of FIGS. 2 and 3, visible light source 202 is configured to emit visible light 211, which may be used by optically active layer 404 (and other optional components) to produce content within a display area of electronic display 401. In this regard, optically active layer 404 is substantially similar to that of optically active layer 204. For example like optically active layer 204, optically active layer 404 may be configured to selectively block or transmit all or a portion of incident visible light, so as to produce content within a display area of electronic display 401. Accordingly, optically active layer 404 may be or include a liquid crystal layer or some other optically active layer, such as described above with respect to the optically active layers of FIGS. 2 and 3.

IR light source 205 in FIG. 4 functions in substantially the same manner as IR light source 205 in FIGS. 2 and 3, in that it is configured to emit IR light 212. Unlike IR light sources 205 in FIGS. 2 and 3 (which introduce IR light 212 directly into a display area of a display (or directly into region 102)), IR light source 205 in FIG. 4 is configured to introduce IR light 212 at a point below optically active layer 404. As will be described later, introduction of IR light 212 in this manner may allow significant flexibility in the design and production of infrared security indicia.

Optional diffuser 403 may include one or more optical components for diffusing visible and/or infrared light. Optional diffuser 403 may therefore in some embodiments include a visible light diffuser that functions in the same manner as optional visible light diffuser 203 described above. Alternatively or additionally, optional diffuser 403 may include one or more optical components for diffusing infrared light emitted by IR light source 205. When used, an infrared diffuser may function to diffuse incident IR light 212 (e.g., from IR light source 205), such that downstream IR light (e.g., which impinges on optically active layer 404) may be more uniform in intensity and/or distribution, relative to corresponding characteristics of IR light 212 upstream of the IR light diffuser. Optional diffuser 403 may therefore include any type of diffuser that is suitable for diffusing visible and/or infrared light.

In some embodiments, optional diffuser 403 includes an IR diffuser that is configured to diffuse incident IR light 212, e.g., such that that IR light downstream of the diffuser is relatively uniform in intensity and/or distribution across all or substantially of the area of optically active layer 404. In other embodiments, an IR diffuser may be used in combination with an optically active layer 404 that is transparent to IR light 212 emitted from IR light source 205. In such instances, the IR diffuser may cause IR light 212 that is uniform or substantially uniform in intensity and/or distribution to impinge and transmit through optically active layer 404. This in turn may cause IR light of substantially uniform intensity and/or distribution to emanate from a display area of electronic display 401 and into region 102. The emanation of IR light 212 in this manner may stimulate and/or saturate all or substantially all of the photosites recording electronic display 401 within a photodetector 103 of an electronic recording device. As a result, all or substantially all of the display area in a recording produced by the electronic recording device may obscured, or “washed out.”

FIG. 5 illustrates another exemplary enhanced security display consistent with the present disclosure. In essence, FIG. 5 illustrates a hybrid of the embodiments of FIGS. 3 and 4, i.e., an embodiment in which sources of IR and visible light are disposed in a backlight unit beneath an optically active layer including a liquid crystal layer. More specifically, FIG. 5 illustrates an exemplary enhanced security display 500 that includes electronic display 401. As shown, electronic display 401 includes backlight unit 501, optional diffusers 403, first and second polarizers 302, 304, optically active layer 404 (including a liquid crystal layer), and optional color filters 304. Backlight 501 includes visible light source 202 and IR light source 205, which respectively function to produce visible light 211 and IR light 212. The nature and function of visible light source 202, first and second polarizers 302, 304, and optically active layer 404 to produce content on a display area of electronic display 401 is the same as described above with respect to FIG. 3, and thus is not reiterated. Rather, the discussion of FIG. 5 focuses on the use of such components in connection with IR light source 205.

As explained previously in connection with FIG. 4, IR light source 205 generally functions to emit IR light 212. IR light 212 may be emitted or otherwise directed towards a display area of electronic display 401. As shown in FIG. 5, IR light 212 emitted from IR light source 205 may be incident on optional diffuser 403, which functions in the same manner as described above.

Regardless of whether optional diffuser 403 is used, IR light 212 may impinge on first polarizer 302, which may be transparent to IR light 212 or configured to transmit IR light having an appropriate polarization ((e.g., a first polarization matching that of first polarizer 302). In some embodiments, first polarizer 302 is configured to be generally transparent to IR light 212. That is, first polarizer 302 may be configured to transmit greater than about 80%, such as about 85%, about 90%, about 95%, about 99% or even 100% of incident IR light 212, while simultaneously filtering visible light 211 based on polarization.

In other embodiments, first polarizer 302 may be configured to simultaneously filter visible light 211 and IR light 212 based on polarization. In such embodiments first polarizer 302 may only transmit visible light 211 and IR light 212 having a polarization that matches its first (e.g., horizontal or vertical) polarization. As will be described later, this may be useful in instances where an optically active layer that is capable of selectively transmitting or blocking IR light is used.

In still other embodiments, first polarizer 302 may include a first visible polarizer and a first infrared polarizer (not separately illustrated). In such embodiments, the first visible polarizer may be transparent or substantially transparent to IR light 212, but may filter visible light 211 based on its polarization. Similarly, the first IR polarizer may be configured to filter IR light 212 based on its polarization, and also to be transparent or substantially transparent to visible light 211.

In any case, IR light 212 (polarized or unpolarized) downstream of first polarizer 302 may be incident on optically active layer 404, which as noted above may include a liquid crystal layer. In some embodiments, optically active layer 404 (e.g., including the liquid crystal layer) may be configured to transmit all or substantially all of incident IR light 212, while selectively transmitting or blocking incident visible light 211. In such embodiments, optically active layer (in conjunction with first and second polarizers 302, 303 and optional color filters 304) may produce content within a display area of electronic display 401 using visible light 211. At the same time, optically active layer 404 may transmit all or substantially all of incident IR light 212. This may be particularly useful in embodiments wherein first polarizer 302 is configured to transmit all or substantially all of IR light 212, regardless of its polarization. In such instances, second polarizer 303 and optional color filters 304 may also be configured to transmit all or substantially all of incident IR light 212.

In other embodiments, optically active layer 404 may include a liquid crystal layer that is capable of selectively transmitting or blocking incident IR light 212, as well as incident visible light 211. For example, optically active layer 404 may be configured to selectively block or transmit IR light 212 and visible light 211, e.g., based on the orientation of the liquid crystals within the layer as generally understood in the art of liquid crystal displays. By controlling the orientation of liquid crystals within liquid crystal “cells” within the liquid crystal layer, optically active layer 404 may selectively transmit or block IR light 212 and visible light 211 at the pixel or even subpixel level.

As may be appreciated, the size, shape and other characteristics of IR security indicia that may be produced by electronic display 401 may be dictated by the distribution and/or intensity of IR light 212 emanating from a display area thereof. In instances where polarizers 302, 303, optically active layer 404, and optional color filter 304 transmit all or substantially all incident IR light 212, the characteristics of IR security indicia produced by the display may be dictated by the distribution of IR light 212 as it is emitted by IR light source(s) 205.

With the foregoing in mind, the present disclosure envisions embodiments wherein backlight unit 501 may include a plurality of IR light sources 205, such as a plurality of IR emitting light emitting diodes. In such instances, all or a plurality of IR light sources 205 may be individually addressed, i.e., such that they may be independently turned on or off and/or varied in intensity. By controlling the addressing of IR light sources 205, (i.e., which sources are turned on and optionally to what intensity), the electronic displays of the present disclosure may produce IR security indicia of a desired shape.

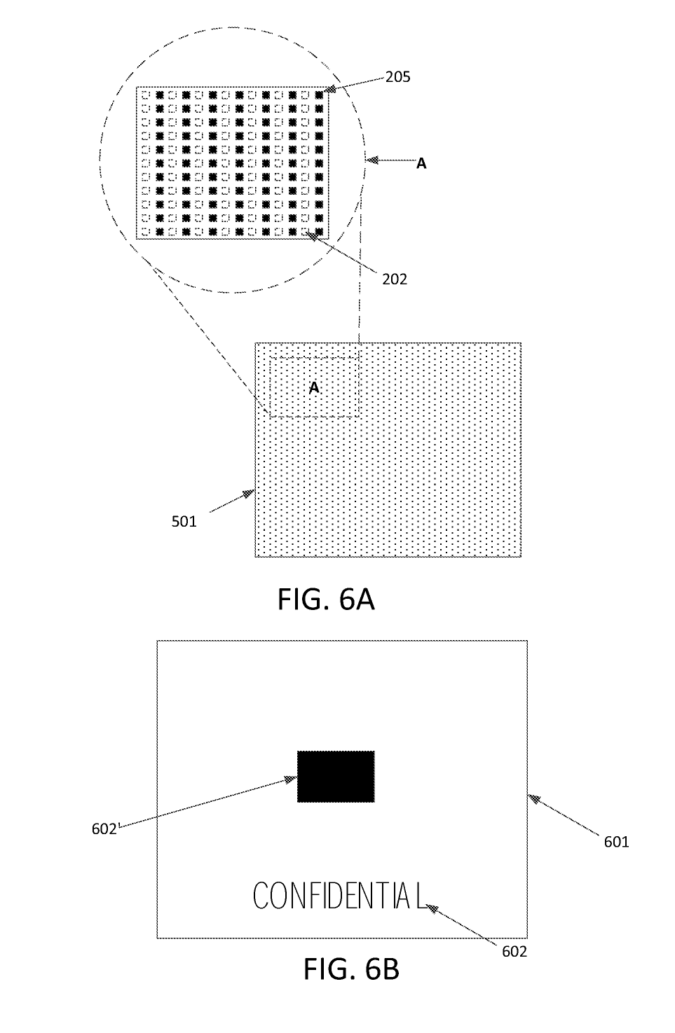

To illustrate this concept, reference is made to FIGS. 6A and 6B. FIG. 6A is a top down view of a backlight unit 501 including a plurality of IR light sources 205 (e.g., a plurality of IR emitting LEDs), and optionally a plurality of visible light sources 202. As shown in the magnified view of area A, the plurality of IR light sources 205 may be arranged in a grid or pixel-like pattern within backlight unit 501. Each of the IR light sources 205 may be individually addressed, such that they may be turned on or off by a controller (not shown). With this in mind, control over the distribution of IR light 212 emitted from backlight unit 501 may be achieved by controlling which IR light sources 205 are turned ON and OFF.

In instances wherein backlight unit is included in an electronic display including IR transparent polarizers and/or optically active layers (e.g., as described above in connection with FIGS. 4 and 5), controlling the distribution of IR light emitted from backlight unit 501 may dictate the distribution of IR light emanating from the electronic display, e.g., into region 103 illustrated in FIGS. 1-4. This in turn may obscure or wash out corresponding portions of the electronic display in a recording thereof produced by an electronic recording device.

This concept is illustrated in FIG. 6B, which illustrates a recorded image 601 of an electronic display produced by an electronic recording device including a photodetector sensitive to IR and visible light emanating from the display. As shown, by controlling which of IR light sources 205 are ON and OFF, it is possible to produce IR security indicia that may be detected by an electronic recording device. For example by controlling individual IR light sources 205, the IR light emitted from backlight unit 501 and ultimately from an electronic display may cause an electronic recording device to produce watermark 602 within recording 601. Similarly, by turning IR light sources 205 in a particular area of backlight unit 501 ON, IR security indicia in the form of obscured region 602′ may be formed within recording 601. Of course, the size and shape of watermark 602 and obscured region 602′ in FIG. 6B are exemplary only, and such IR security indicia may have any desired shape.

As may be appreciated, IR security indicia in the form of obscured regions 602′ may be particularly useful in instances where only a portion of the content on an electronic display needs to be protected from electronic recording. For example in the medical records context, obscured region 602′ may be used to prevent electronic recording of sensitive patient records (e.g., patent name, identification number, etc.), while permitting electronic recording of non-sensitive information that may be simultaneously present on the display. This may facilitate the legal distribution of patient records while complying with relevant privacy laws.

Returning to FIG. 5, as noted previously the present disclosure envisions embodiments wherein the distribution of IR light emanating from electronic display is dictated by optically active layer 404, rather than IR light sources 205. For example, optically active layer 404 may include a liquid crystal layer that is capable of selectively transmitting or blocking incident IR light 212, as well as incident visible light 211, e.g., based on the orientation of the liquid crystals within the layer as generally understood in the art of liquid crystal displays. By controlling the orientation of liquid crystals within liquid crystal “cells” within the liquid crystal layer, optically active layer 404 may selectively transmit or block IR light 212 and visible light 211 at the pixel or even subpixel level. This may allow complex IR security indicia to be formed by selectively transmitting IR light 212, e.g., in the same manner as content is produced with visible light 211.

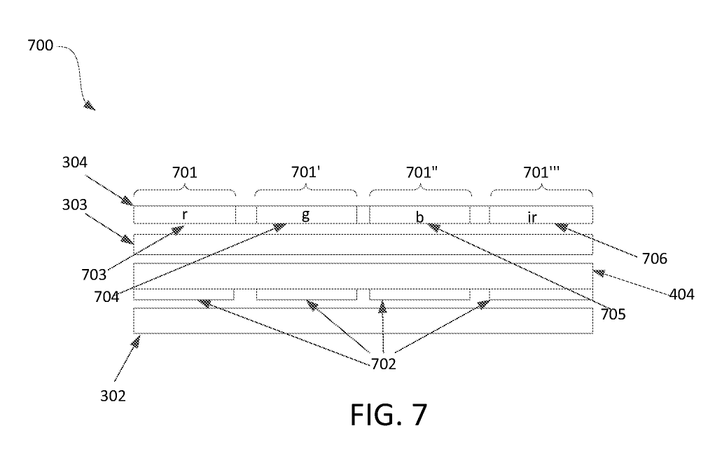

To illustrate this concept reference is made to FIG. 7, which depicts an exemplary liquid crystal display (LCD) pixel 700 consistent with the present disclosure. For the sake of clarity and ease of understanding FIG. 7 illustrates one LCD pixel 700. It should be understood this illustration is exemplary, and that the electronic displays of the present disclosure may include a plurality of LCD pixels, such as may be found in a standard or high definition LCD display.

In the illustrated embodiment, LCD pixel 700 includes a plurality of subpixels, or “cells,” each of which is associated with a corresponding color/IR filter, second polarizer 303, optically active layer 404 and first polarizer 302. As shown, LCD pixel 700 includes four LCD cells, 701, 701′, 701″, 701′″, one for each of four different filters. With this in mind, each cell may further include a mechanism for individually controlling the orientation of liquid crystals within liquid crystal layer of optically active layer 404. For example, each cell may include a thin film transistor (TFT) 702 or other control mechanism, which may change the orientation of liquid crystals in the liquid crystal layer in response to a control signal, thus allowing a cell to selectively block or transmit visible and/or infrared light as generally understood in the art of TFT liquid crystal displays. Of course, such control mechanism is exemplary only, and mechanisms other than TFTs 702 may be used to control the orientation of liquid crystals within each cell.

As further shown in FIG. 7 and generally described above, each LCD pixel may include a plurality of cells. In the illustrated embodiment, LCD pixel 700 includes first, second and third cells 701, 701′, 701″, which are respectively associated with red, green, and blue color filters 703, 704, 705. As generally understood in the art of color LCD displays, red, green and blue filters 703, 704, 705 may be included on a filter layer, and function to filter various portions of visible light transmitted by a corresponding portion of optically active layer 404, so as to transmit light within a specified portion of the visible region of the electromagnetic spectrum. By mixing light output from cells 701, 701′, 701″, LCD pixel 700 (in combination with other LCD pixels) may produce color content on a display of an electronic device.

As further shown in FIG. 7, the present disclosure envisions embodiments wherein LCD pixel 700 further include fourth LCD cell 701″′, which is associated with infrared filter 701′″ that may also be included in a filter layer. Conceptually, cell 701′″ works in substantially the same fashion as cells 701, 701′, and 701″, except insofar as it functions to selectively transmit infrared light. For example, a controller may controller a plurality of LCD pixels 700, so as to produce color content in a display area of an electronic display, e.g., using cells 701, 701′, and 701″. At the same time, the controller may produce infrared security indicia within the display area by selectively transmitting or block IR light, e.g., with cell 701′″. As may be appreciated, IR light transmitted through cell 701′″ may hinder or prevent an electronic recording device from properly recording visible light transmitted by cells 701, 701′, and 701″. In instances where a plurality of (e.g., all) LCD pixels in an electronic display include cell 701′″, complex IR security indicia may be produced which obscure portions of content on an electronic display at the pixel or even subpixel level. By appropriately controlling each cell 701″′, IR security indicia of significant complexity may be produced.

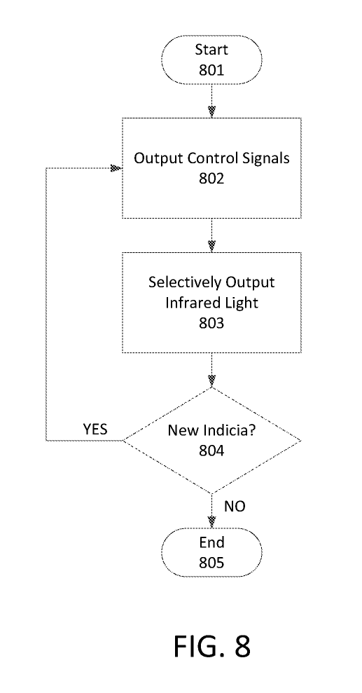

Another aspect of the present disclosure relates to a method for producing IR security indicia with an enhanced security display. Reference is therefore made to FIG. 8, which depicts an exemplary method of producing IR security indicia consistent with the present disclosure. As shown, the method begins at block 801. At block 802, control signals (e.g., from a controller, as described below) may be output to an enhanced security display, so as to cause the display to selectively output infrared light. Consistent with the foregoing description, the infrared light may be emitted such that it emanates from at least a portion of a display region of an electronic display, and is configured to produce infrared security indicia within a recording of the display area produced by an electronic recording device.

In instances where the electronic display includes an optically active layer and a backlight unit comprising a visible light source (e.g., as shown in FIGS. 3 and 5), operations pursuant to blocks 802 and 803 may include outputting control signals (e.g., from a controller) to the backlight unit to cause the backlight unit to emit visible light that is at least partially transmitted through the optically active layer to produce content within the display area of the electronic display.

As noted above, an infrared light source may be incorporated into an electronic display bout an optically active layer, such as a liquid crystal layer. For example, the infrared light sources may be offset from an upper surface of an optically active layer. In such instances, operations pursuant to blocks 802 and 803 may include transmitting control signals to the infrared light sources such that they emit infrared light into a diffuser and/or a region above the optically active layer, e.g., so as to at least partially obscure substantially all of a recording of a display area produced by an electronic device.

In instances where an electronic display includes a backlight that includes an IR light source, operations pursuant to blocks 802 and 803 may include outputting control signals (e.g., from a controller) to the IR light source, so as to cause the IR light source to emit IR light that is transmitted at least partially through an optically active layer of the electronic display, and optionally through one or more IR filters disposed on the optically active layer.

In instances where an enhanced security display includes a backlight unit comprising a plurality of individually addressed IR emitting light sources (e.g., IR emitting LEDs as shown in FIG. 6A), operations pursuant to blocks 802 and 803 may include outputting control signals (e.g., from a controller) to the IR sources in the backlight unit. The control signals may cause the IR light sources to selectively output IR light in a desired distribution. For example, such signals may cause the backlight unit to turn ON IR light sources in a pattern corresponding to a desired IR security indicia, while leaving other IR light sources OFF. In this way, the IR light sources that are turned ON may produce IR light in a distribution corresponding to the IR security indicia, such as a watermark, an obscured region, or a combination thereof.

The IR light so produced may be transmitted through various components of the enhanced security display as discussed above, until it emanates from the display. Such light may cause an electronic recording devices to produce a recording in which the IR security indicia obscures at least a portion of a recording of the display, as generally discussed above. Where content is produced by the electronic display as well, the IR security indicia may also be configured to at least partially obscure said content in a recording of the display produced by an electronic recording device. For example, the IR security indicia may in the form of a watermark, an obscured area, or a combination thereof.

In instances where an enhanced security display includes an optically active layer including a liquid crystal layer and a plurality of individually addressed liquid crystal pixels (e.g., as shown in FIG. 7), operations pursuant to blocks 802 and 803 may include transmitting control signals to one or more of such pixels. Such control signals may pursuant to block 803 cause the pixels to selectively transmit infrared light. For example, the control signals may be configured to cause one or more cells of the pixels to selectively transmit infrared light, as generally described above in connection with FIG. 7. More particularly, the control signals may cause a plurality of first liquid crystal cells (first cells) to selectively block or transmit IR light, such that the distribution of IR light aggregately transmitted through such first cells (and optionally an IR filter associated therewith) has a distribution corresponding to a desired IR security indicia. IR light transmitted by such first cells may ultimately emanate from the display, where it may cause electronic recording device to produce a recording in which the IR security indicia obscures at least a portion of a recording of the display, as discussed previously.

Similarly, pixels within a liquid crystal layer may include a plurality of second cells that are configured to selective transmit or block visible light. In such instance, operations pursuant to blocks 802 and 803 may include transmitting control signals to such second cells, wherein the control signals are configured to cause said second cells to transmit or block said visible light to produce content in a display area of the electronic display.

In any case, once IR light has been selectively output pursuant to block 803, the method may proceed to optional block 804, wherein a determination may be made (e.g., by a controller) as to whether a new IR security indicia is required. If so, the method may loop back to block 802, wherein control signals configured to produce the new IR security indicia are output. If no new indicia is required (or if block 804 is omitted), the method may proceed to block 805 and end.

Another aspect of the present disclosure relates to a computer readable medium including instructions for producing infrared security indicia with an enhanced security display consistent with the present disclosure. Such computer a computer readable medium may include or be in the form of a secure indicia module (SIM) module. The SIM may include computer readable SIM instructions which when executed by a processor (e.g., of a display controller) may cause the processor to perform infrared security indicia production operations consistent with the present disclosure. For example, the SIM instructions when executed may cause the controller to output control signals to an enhanced security display, e.g., in a manner consistent with the description of blocks 802 and 803 of FIG. 8.

The SIM instructions when further executed may further cause a processor (e.g., of a display controller) to monitor for a request (e.g., input by a user) for a new IR security indicia, as generally described above with respect to block 804 of FIG. 8. In response to such a request, the SIM instructions when executed may cause the processor to output control signals configured to produce the new IR security indicia, as described above.

As may be appreciated from the foregoing, the technologies described herein may provide a convenient and user friendly mechanism for protecting content on a display from being recorded by an electronic recording device. Although numerous end uses are contemplated, the technologies described herein are believed to have particular use in industries where maintaining the confidentiality of records is important, such as the medical records industry. As described above, the technologies of the present disclosure may be used to hinder or prevent all or substantially all of a display area of an electronic display from being reproduced in an electronic recording of the display. Alternatively, select regions of the display area may be obscured in a recording, thus enabling the redaction of only confidential information from a recording of a display.

For the sake of clarity, the present disclosure will now describe several examples of the technology described herein. Such examples are presented for the sake of illustration only, and should not be considered to be restrictive of the general concepts described herein.

### EXAMPLES

### Example 1

In this example there is provided an enhanced security display, including: a display configured to display content within a display area of the display; and an infrared light source integrated into the display, the infrared light source to emit infrared light that is configured to cause an electronic recording device to produce infrared security indicia within a recording of the display area.

### Example 2

This example includes any or all of the elements of example 1, wherein the infrared security indicia obscures at least a portion of the content within the recording.

### Example 3

This example includes any or all of the elements of example 1 wherein the display includes: an optically active layer; and a backlight unit configured to transmit visible light through the optically active layer.

### Example 4

This example includes any or all of the elements of example 3, wherein the infrared light source is positioned above the optically active layer.

### Example 5

This example includes any or all of the elements of example 4, wherein the infrared light source includes at least one infrared emitting light emitting diode.

### Example 6

This example includes any or all of the elements of example 4, wherein: the optically active layer has an upper surface; and the infrared light source is offset from the upper surface.

### Example 7

This example includes any or all of the elements of example 6, and further includes an infrared diffusion layer on the optically active layer, wherein the infrared diffusion layer is configured to receive and diffuse the infrared light so as to produce the infrared security indicia.

### Example 8

This example includes any or all of the elements of example 7, wherein the infrared security indicia obscures at least a portion of the content across substantially all of an electronic recording of the display area.

### Example 9

This example includes any or all of the elements of any one of examples 3 to 8, wherein the optically active layer includes a liquid crystal layer.

### Example 10

This example includes any or all of the elements of example 3, wherein the backlight unit includes the infrared light source, and the backlight unit is configured to transmit at least a portion of the infrared light through the optically active layer.

### Example 11

This example includes any or all of the elements of example 10, and further includes a filter layer on the optically active layer, the filter layer including an infrared filter to transmit at least a portion of the infrared light.

### Example 12

This example includes any or all of the elements of example 10, wherein: the infrared light source includes a plurality of individually addressed infrared light sources; the optically active layer is transparent to infrared light emitted from the plurality of infrared light sources; and the plurality of infrared light sources are configured to produce the infrared security indicia in a shape consistent with an addressing of the infrared light sources.

### Example 13

This example includes any or all of the elements of example 12, wherein the infrared security indicia is selected from the group consisting of a watermark, an obscured region, and combinations thereof.

### Example 14

This example includes any or all of the elements of example 11, wherein: the optically active layer includes a plurality of liquid crystal pixels; and at least one of the liquid crystal pixels includes a first cell associated with the infrared filter, the first cell configured to selectively transmit or block the infrared light.

### Example 15

This example includes any or all of the elements of example 14, wherein the optically active layer further includes a second cell configured to selectively transmit or block the visible light.

### Example 16

This example includes any or all of the elements of example 15, wherein the filter layer further includes a visible light filter associated with the second cell.

### Example 17

This example includes any or all of the elements of example 16, wherein: the optically active layer includes a plurality of the first and second cells; and the enhanced security display further includes a display controller configured to control the plurality of first and second cells to produce the content with the visible light, and the infrared security indicia with the infrared light.

### Example 18

According to this example there is provided a method of protecting content on an electronic display, including: emitting infrared light from an infrared light source incorporated into the electronic display, such that the infrared light emanates from at least a portion of a display region of the electronic display, wherein the infrared light is configured to cause an electronic recording device to produce infrared security indicia within a recording of the display area, the infrared security indicia at least partially obscuring at least a portion of the display area in the recording.

### Example 19

This example includes any or all of the elements of example 18, and further includes producing content within the display area using visible light, wherein the infrared security indicia is configured to at least partially obscure at least a portion of the content within the recording of the display area.

### Example 20

This example includes any or all of the elements of example 18, wherein the infrared security indicia is a watermark.

### Example 21

This example includes any or all of the elements of example 18, wherein the electronic display further includes an optically active layer and a backlight unit including a visible light source for emitting the visible light, and the method further includes transmitting at least a portion of the visible light through the optically active layer to produce the content.

### Example 22

This example includes any or all of the elements of example 18, wherein the electronic display further includes an optically active layer, and the infrared light source is positioned above the optically active layer.

### Example 24

This example includes any or all of the elements of example 22 wherein the electronic display further includes an infrared diffuser, and the method further includes diffusing the infrared light within the infrared diffuser so as to at least partially obscure substantially all of the display area in the recording.

### Example 24

This example includes any or all of the elements of example 18, wherein the infrared light source includes at least one infrared emitting light emitting diode.

### Example 25

This example includes any or all of the elements of example 22, wherein the optically active layer has an upper surface; and the source of infrared light is offset from the upper surface.

### Example 26

This example includes any or all of the elements of examples 21 to 25, wherein the optically active layer includes a liquid crystal layer.

### Example 27

This example includes any or all of the elements of example 21, wherein the backlight unit includes the infrared light source, and the method further includes transmitting at least a portion of the infrared light through the optically active layer.

### Example 28

This example includes any or all of the elements of example 27, wherein the electronic display further includes a filter layer including an infrared filter on the optically active layer, and the method further includes transmitting at least a portion of the infrared light through the infrared filter.

### Example 29

This example includes any or all of the elements of example 27, wherein: the infrared light source includes a plurality of individually addressed infrared light sources; the optically active layer is transparent to infrared light emitted from the plurality of infrared light sources; and the method further includes addressing the plurality of the infrared light sources such that they emit the infrared light in a shape corresponding to the infrared security indicia.

### Example 30

This example includes any or all of the elements of example 29, wherein the infrared security indicia is selected from the group consisting of a watermark, an obscured region, and combinations thereof.

### Example 31

This example includes any or all of the elements of example 28, wherein the optically active layer includes a plurality of liquid crystal pixels, wherein at least one of the liquid crystal pixels includes a first cell associated with the infrared filter, and the method further includes selectively transmitting or blocking the infrared light with the first cell.

### Example 32

This example includes any or all of the elements of example 31, wherein at least one of the liquid crystal pixels includes a second cell associated with a visible light filter, and the method further includes selectively transmitting or blocking the visible light with the second cell.

### Example 33

This example includes any or all of the elements of example 32, wherein the electronic display includes a plurality of the first cells and second cells and further includes a display controller, and the method further includes using the display controller to control the plurality of first and second cells to produce the content with the visible light, and the infrared security indicia with the infrared light.

### Example 34

According to this example there is provided at least one computer readable medium including computer readable security image module (SIM) instructions thereon, wherein the SIM instructions when executed by a processor cause the processor to perform the following operations including: emitting infrared light from an infrared light source incorporated into an electronic display, such that the infrared light emanates from at least a portion of a display region of the electronic display, wherein the infrared light is configured to cause an electronic recording device to produce infrared security indicia within a recording of the display area, the infrared security indicia at least partially obscuring at least a portion of the display area in the recording.

### Example 35

This example includes any or all of the elements of example 34, wherein the SIM instructions when executed further cause the processor to cause the electronic display to produce content within the display area using visible light, wherein the infrared security indicia is configured to at least partially obscure at least a portion of the content within the recording of the display area.

### Example 36

This example includes any or all of the elements of example 34, wherein the infrared security indicia is a watermark.

### Example 37

This example includes any or all of the elements of example 34, wherein the electronic display further includes an optically active layer and a backlight unit including a visible light source for emitting the visible light, and the SIM instructions when executed further cause the processor to perform the following operations including causing the electronic display to transmit at least a portion of the visible light through the optically active layer to produce the content.

### Example 38

This example includes any or all of the elements of example 34, wherein the electronic display further includes an optically active layer, and the infrared light source is positioned above the optically active layer.

### Example 39

This example includes any or all of the elements of example 38, wherein the electronic display further includes an infrared diffuser, and the SIM instructions when executed further cause the processor to cause the infrared light source to emit the infrared light into the diffuser, such that electronic display produces the security indicia to at least partially obscure all of the display area within the recording.

### Example 40

This example includes any or all of the elements of example 34, wherein the infrared light source includes at least one infrared emitting light emitting diode.

### Example 41

This example includes any or all of the elements of example 38, wherein: the optically active layer has an upper surface; and the source of infrared light is offset from the upper surface.

### Example 42

This example includes any or all of the elements of any one of examples 37 to 41, wherein the optically active layer includes a liquid crystal layer.

### Example 43

This example includes any or all of the elements of example 37, wherein the backlight unit includes the infrared light source, and the SIM instructions when executed further cause the processor to cause the electronic display to transmit at least a portion of the infrared light through the optically active layer.

### Example 44

This example includes any or all of the elements of example 43, wherein the electronic display further includes a filter layer including an infrared filter on the optically active layer, and the SIM instructions when executed further cause the electronic display to transmit at least a portion of the infrared light through the infrared filter.

### Example 45

This example includes any or all of the elements of example 43, wherein: the infrared light source includes a plurality of individually addressed infrared light sources; the optically active layer is transparent to infrared light emitted from the plurality of infrared light sources; and the SIM instructions when executed further cause the processor to address the plurality of the infrared light sources such that they emit the infrared light in a shape corresponding to the infrared security indicia.

### Example 46

This example includes any or all of the elements of example 45, wherein the infrared security indicia is selected from the group consisting of a watermark, an obscured region, and combinations thereof.

### Example 47

This example includes any or all of the elements of example 44, wherein: the optically active layer includes a plurality of liquid crystal pixels; at least one of the liquid crystal pixels includes a first cell associated with the infrared filter; and the SIM instructions when executed further cause the processor to cause the electronic display to selectively transmit or block the infrared light with the first cell.

### Example 48

This example includes any or all of the elements of example 47, wherein at least one of the liquid crystal pixels includes a second cell associated with a visible light filter, and the SIM instructions when executed further cause the processor to cause the electronic device to selectively transmit or block the visible light with the second cell.

### Example 49

This example includes any or all of the elements of example 48, wherein the electronic display includes a plurality of the first cells and second cells, and the SIM instructions when executed further cause the processor to control the plurality of first and second cells to produce the content with the visible light, and the infrared security indicia with the infrared light.

### Example 50

According to this example there is provided at least one computer readable medium including a plurality of instructions that when executed by a electronic device cause the electronic device to perform the method according to any one of examples 18 to 33.

### Example 51

According to this example there is provided a system including at least one device arranged to perform the method of any one of examples 18 to 33.

### Example 52

According to this example there is provided an electronic display including means to perform the method according to any one of examples 18 to 33.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-25. (canceled)

26. An enhanced security display, comprising:
a display configured to display visible content within a display area of said display; and
an infrared light source integrated into said display, the infrared light source to emit infrared light that is configured to cause an electronic recording device to produce infrared security indicia within a recording of said display area.

27. The enhanced security display of claim 26, wherein said display comprises:
an optically active layer; and
a backlight unit configured to transmit visible light through the optically active layer.

28. The enhanced security display of claim 27, wherein said infrared light source comprises at least one infrared emitting light emitting diode.

29. The enhanced security display of claim 27, wherein said optically active layer comprises a liquid crystal layer.

30. The enhanced security display of claim 27, wherein said backlight unit comprises said infrared light source, and said backlight unit is configured to transmit at least a portion of said infrared light through said optically active layer.

31. The enhanced security display of claim 27, wherein:
said infrared light source comprises a plurality of individually addressed infrared light sources;
said optically active layer is transparent to infrared light emitted from said plurality of infrared light sources; and
said plurality of infrared light sources are configured to produce said infrared security indicia in a shape consistent with an addressing of said infrared light sources.

32. The enhanced security display of claim 31, wherein:
said optically active layer comprises a plurality of liquid crystal pixels;
at least one of said liquid crystal pixels comprises a first cell associated with an infrared light filter, said first cell configured to selectively transmit or block said infrared light; and
at least one of said liquid crystal pixels comprises a second cell associated with a visible light filter, the second cell configured to selectively transmit or block said visible light.

33. The enhanced security display of claim 32, wherein:
said optically active layer comprises a plurality of said first and second cells; and
said enhanced security display further comprises a display controller configured to control said plurality of first and second cells to produce said visible content with said visible light, and said infrared security indicia with said infrared light.

34. A method of protecting content on an electronic display, comprising:
emitting infrared light from an infrared light source incorporated into said electronic display, such that said infrared light emanates from at least a portion of a display region of said electronic display, wherein said infrared light is configured to cause an electronic recording device to produce infrared security indicia within a recording of said display area, said infrared security indicia at least partially obscuring at least a portion of said display area in said recording.

35. The method of claim 34, further comprising producing content within said display area using visible light, wherein said infrared security indicia is configured to at least partially obscure at least a portion of said content within said recording of said display area.

36. The method of claim 34, wherein said electronic display further comprises an optically active layer and a backlight unit comprising a visible light source for emitting said visible light, and the method further comprises transmitting at least a portion of said visible light through an optically active layer of said electronic display to produce said content.

37. The method of claim 34, wherein said infrared light source comprises at least one infrared emitting light emitting diode.

38. The method of claim 36, wherein said optically active layer comprises a liquid crystal layer.

39. The method of claim 38, wherein:
said infrared light source comprises a plurality of individually addressed infrared light sources;
said optically active layer is transparent to infrared light emitted from said plurality of infrared light sources; and
the method further comprises addressing said plurality of said infrared light sources such that they emit said infrared light in a shape corresponding to said infrared security indicia.

40. The method of claim 39, wherein said optically active layer comprises a plurality of liquid crystal pixels, wherein at least one of said liquid crystal pixels comprises a first cell associated with an infrared filter and at least one of said liquid crystal pixels comprises a second cell associated with a visible light filter, wherein the method further comprises selectively transmitting or blocking said infrared light with said first cell and selectively transmitting or blocking said visible light with said second cell.

41. The method of claim 40, wherein the electronic display comprises a plurality of said first cells and second cells and further comprises a display controller, and the method further comprises using said display controller to control said plurality of first and second cells to produce said content with said visible light, and said infrared security indicia with said infrared light.

42. At least one computer readable medium comprising computer readable security image module (SIM) instructions thereon, wherein said SIM instructions when executed by a processor cause the processor to perform the following operations comprising:
emitting infrared light from an infrared light source incorporated into an electronic display, such that said infrared light emanates from at least a portion of a display region of said electronic display, wherein said infrared light is configured to cause an electronic recording device to produce infrared security indicia within a recording of said display area, said infrared security indicia at least partially obscuring at least a portion of said display area in said recording.

43. The at least one computer readable medium of claim 42, wherein said SIM instructions when executed further cause said processor to cause said electronic display to produce content within said display area using visible light, wherein said infrared security indicia is configured to at least partially obscure at least a portion of said content within said recording of said display area.

44. The at least one computer readable medium of claim 42, wherein said electronic display further comprises an optically active layer and a backlight unit comprising a visible light source for emitting said visible light, and said SIM instructions when executed further cause said processor to perform the following operations comprising causing said electronic display to transmit at least a portion of said visible light through an optically active layer of said electronic display to produce said content.

45. The at least one computer readable medium of claim 42, wherein said infrared light source comprises at least one infrared emitting light emitting diode.

46. The at least one computer readable medium of claim 44, wherein said optically active layer comprises a liquid crystal layer.

47. The at least one computer readable medium of claim 46, wherein said backlight unit comprises said infrared light source, and said SIM instructions when executed further cause said processor to cause said electronic display to transmit at least a portion of said infrared light through said optically active layer.

48. The at least one computer readable medium of claim 47, wherein:
said infrared light source comprises a plurality of individually addressed infrared light sources;
said optically active layer is transparent to infrared light emitted from said plurality of infrared light sources; and
said SIM instructions when executed further cause said processor to address said plurality of said infrared light sources such that they emit said infrared light in a shape corresponding to said infrared security indicia.

49. The at least one computer readable medium of claim 47, wherein:
said optically active layer comprises a plurality of liquid crystal pixels;
at least one of said liquid crystal pixels comprises a first cell associated with an infrared light filter;
at least one of said liquid crystal pixels comprises a second cell associated with a visible light filter; and
said SIM instructions when executed further cause said processor to cause said electronic display to selectively transmit or block said infrared light with said first cell and selectively transmit or block said visible light with said second cell.

50. The at least one computer readable medium of claim 49, wherein the electronic display comprises a plurality of said first cells and second cells, and said SIM instructions when executed further cause said processor to control said plurality of first and second cells to produce said content with said visible light, and said infrared security indicia with said infrared light.
